(19) United States
(12) Patent Application Publication
(10) Pub. No.: US 2011/0212357 A1
(43) Pub. Date: Sep. 1, 2011

(54) BATTERY, VEHICLE, AND BATTERY-MOUNTING EQUIPMENT

(76) Inventor: Masakazu Umehara, Aichi (JP)

(21) Appl. No.: 13/127,075

(22) PCT Filed: Nov. 7, 2008
(86) PCT No.: PCT/JP2008/070306

§ 371 Date: May 2, 2011

(51) Int. Cl. H01M 2/16

(52) U.S. Cl. 429/144

(57) ABSTRACT

This invention provides a battery comprising a separator, which has a shutdown function and, at the same time, can suppress a lowering in output of the battery, a vehicle with the battery mounted thereon, and a battery mounted equipment. A battery (1) comprises a positive electrode plate (31), a negative electrode plate (41), and a separator (20). The separator comprises a porous resin layer (21) formed of a polyolefin-type synthetic resin and an inorganic oxide layer (27) layered on the resin layer (21). First particles (P1), which are independent single crystal particles, and second particles (P2), which are connected particles comprising a plurality of particulate parts formed of a single crystal connected to each other in chains and integrated with each other, are dispersed in each other in the inorganic oxide layer (27).

### CROSS-REFERENCE TO RELATED APPLICATIONS

This is a national phase application based on the PCT International Patent Application No. PCT/JP2008/070306 filed on Nov. 7, 2008, the entire contents of which are incorporated herein by reference.

### TECHNICAL FIELD

The present invention relates to a battery including a separator, a vehicle that mounts the battery, and a battery-mounting equipment that mounts the battery.

### BACKGROUND ART

In recent years, proliferation of portable electronic devices such as a cellular phone, a notebook computer, and a video camcorder, and vehicles such as a hybrid electric vehicle and a plug-in hybrid electric vehicle has increased the demands for batteries to be used as power supplies for driving the above devices.

Some of such batteries include porous separators made of insulating synthetic resin placed between positive electrode plates and negative electrode plates. Some batteries of this type have a shutdown function of preventing the thermal runaway of a battery by utilizing a separator made of synthetic resin ((e.g., thermoplastic polyethylene (a melting point: about 130° C.) having a lower melting point (or a softening point) than a temperature (e.g., about 1000° C. or higher) that causes the battery thermal runaway. This shutdown function represents a function of preventing the battery thermal runaway by melting (or softening) the separator when abnormal heat generation occurs in the battery due to e.g. short circuits and the battery internal temperature rises beyond the melting point (or the softening point) of the separator, the separator melts (or softens), closing pores in the separator, thereby blocking a current from flowing between the positive electrode plate and the negative electrode plate.

To ensure such shutdown function of the separator, the separator has to maintain its shape even when the temperature of the separator exceeds the melting point. For example, Patent Literature 1 has proposed a battery including a separator in which a heat-resistant porous layer including heat-resistant particles is formed on the surface of a porous resin film made of thermoplastic resin.

### CITATION LIST

### Patent Literature

Patent Literature 1: JP2008-123996A

### SUMMARY OF INVENTION

### Technical Problem

However, in the battery of this type, the amount of electrolyte retained in an inorganic oxide layer is smaller as the porosity of the heat-resistant porous layer (the inorganic oxide layer) is lower. Accordingly, lithium ions are less likely to diffuse, resulting in lower battery output.

On the other hand, even when the heat-resistant porous layer (the inorganic oxide layer) is formed to exhibit high porosity, this layer (the inorganic oxide layer) is compressed when an electrode expands due to battery charge and discharge, thereby gradually decreasing the porosity. Thus, the battery output lowers.

The present invention has been made to solve the above problems and has a purpose to provide a battery including a separator capable of providing a shutdown function and also restraining lowering of battery output of the battery. Another purpose of the present invention is to provide a vehicle that mounts the battery and a battery-mounting equipment that mounts the battery.

### Solution to Problem

To achieve the above purpose, one aspect of the invention provides a battery comprising a positive electrode plate, a negative electrode plate, and a separator interposed between the positive electrode plate and the negative electrode plate, wherein the separator includes: a porous resin layer made of polyolefin synthetic resin; and an inorganic oxide layer layered on at least one side of the resin layer in a thickness direction, the inorganic oxide layer includes: first particles made of first inorganic oxide in the form of separate single crystal particles; and second particles made of second inorganic oxide in the form of connected particles comprising a plurality of particulate parts integrally connected to each other in chains, each particulate part being made of a single crystal.

In the battery of the invention, in the inorganic oxide layer of the separator, the aforementioned first particles and the second particles are dispersed respectively. Such battery can retain its battery output even after charge and discharge are repeated. The second particles of the inorganic oxide layer are connected particles comprising a plurality of particulate parts connected to each other in chains. Thus, differently from the case of using only the first particles in the inorganic oxide layer, it is conceivable that the porosity can be maintained by the existence of the second particles even when the inorganic oxide layer is compressed by charge and discharge of the battery.

Therefore, the battery can include a shutdown function for preventing thermal runaway of the battery while keeping the shape of the separator even if the resin layer melts, and further can retain its battery output even though it includes the inorganic oxide layer in the separator.

The first and second inorganic oxides may include aluminum oxide (Al₂O₃), magnesium oxide (MgO), ferric oxide (FeO, Fe₂O₃), silicon dioxide (SiO₂), titanium oxide (TiO₃), and barium titanate (BaTiO₃). The first and second inorganic oxides may be the same or different in composition.

In the above battery, preferably, the first inorganic oxide is magnesium oxide, the second inorganic oxide is aluminum oxide, and the inorganic oxide layer includes 80 to 95 wt % of the second particles with respect to a total weight of the first particles and the second particles.

In the battery of the invention, the inorganic oxide layer contains the second particles made of aluminum oxide of 80 wt % to 95 wt % of the total mass of the first particles and the second particles. Thus, the battery can surely retain battery output.

Magnesium oxide which is the first inorganic oxide and aluminum oxide which is the second inorganic oxide are both stable and less likely to cause defects resulting from dissolution of components and others.

Furthermore, aluminum oxide and magnesium oxide are lower in price than other inorganic oxides, so that the inorganic oxide layer and hence the battery are reduced in cost.

The connected particles of aluminum oxide which are the second particles are preferably particles having for example 4.0 to 8.0 m²/g of a specific surface defined by a BET method. The single crystal particles of magnesium oxide which are the first particles are preferably particles having for example 9.0 to 13.0 m²/g of a specific surface.

Another aspect of the invention provides a vehicle that mounts one of the aforementioned batteries.

The vehicle of the invention mounts the aforementioned battery and thus can be provided as a vehicle using a safer battery and retaining battery output to maintain a vehicle performance.

The vehicle may be any vehicle using electric energy of the battery in the whole or part of its power source. For instance, the vehicle may include an electric vehicle, a hybrid vehicle, a plug-in hybrid vehicle, a hybrid railroad vehicle, a forklift, an electric-driven wheel chair, an electric bicycle, an electric scooter, etc.

Furthermore, another aspect of the invention provides a battery-mounting equipment that mounts one of the aforementioned batteries.

The battery-mounting equipment of the invention mounts the aforementioned battery and thus can be provided as a battery-mounting equipment using a safer battery and retaining battery output to maintain its own performance.

The battery-mounting equipment may be any device mounted with a battery and arranged to utilize this battery as at least one of energy sources. For instance, the device may include any one of various battery-driven home electric appliances, office equipment, and industrial equipment such as a personal computer, a cellular phone, a battery-driven electric tool, an uninterruptible power supply system.

### BRIEF DESCRIPTION OF DRAWINGS

FIG. 1 is a partly cross-sectional view of a battery in a first embodiment;

FIG. 2 is a cross-sectional view (along a line A-A in FIG. 1) of the battery in the first embodiment;

FIG. 3A is a cross-sectional view (along a line B-B in FIG. 1) to explain the battery in the first embodiment;

FIG. 3B is an enlarged cross-sectional view (Part C) to explain the battery in the first embodiment;

FIG. 4 is an enlarged cross-sectional view of a separator in the first embodiment;

FIG. 5 is a perspective view of first particles in the first embodiment;

FIG. 6 is a perspective view of second particles in the first embodiment;

FIG. 7 is an explanatory view of a nail penetration test in the first embodiment;

FIG. 8 is an explanatory view of a vehicle in a second embodiment; and

FIG. 9 is an explanatory view of a hammer drill in a third embodiment.

### REFERENCE SIGNS LIST

1 Battery
2 Separator
21 Resin base layer (Resin layer)
27 Inorganic oxide layer
31 Positive electrode plate
41 Negative electrode plate
200 Vehicle
210 Battery assembly (Battery)
300 Hammer drill (Battery-mounting equipment)
310 Battery pack (Battery)
DT Thickness direction (of Resin base layer)
P1 First particles
P2 Second particles
PG Particulate parts

### DESCRIPTION OF EMBODIMENTS

### First Embodiment

A detailed description of a preferred first embodiment of the present invention will now be given referring to the accompanying drawings.

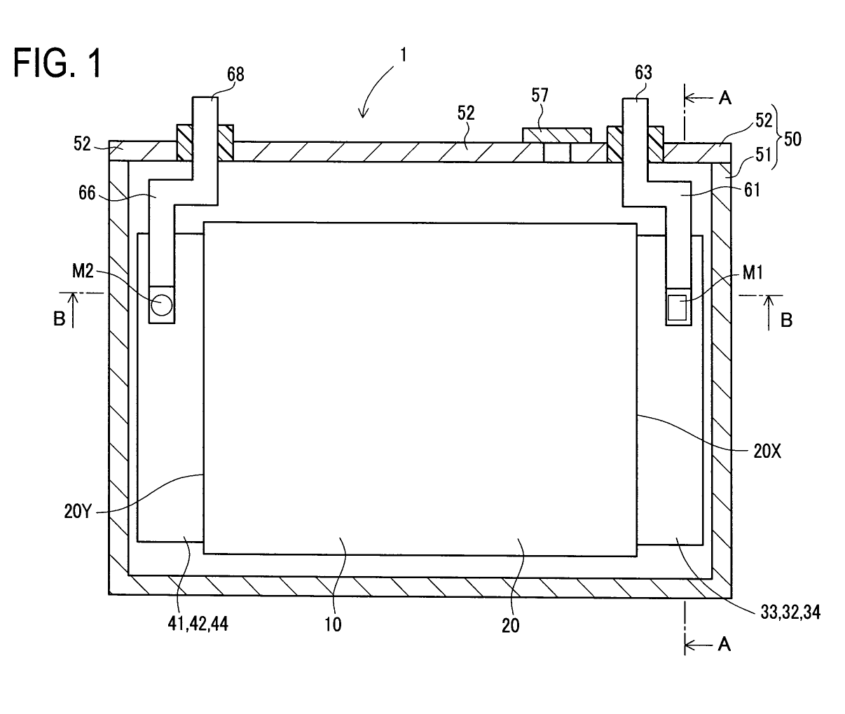

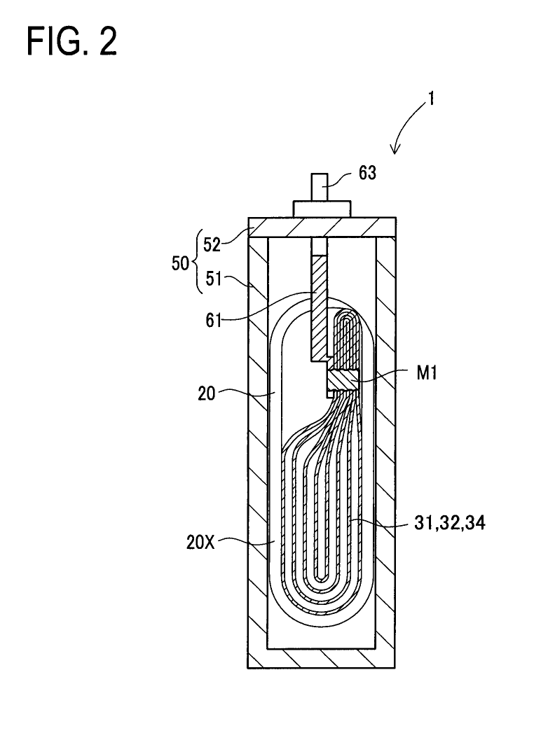

A battery 1 in the first embodiment is a lithium ion secondary battery including, as shown in FIGS. 1 and 2, a power generating element 10 consisting of a positive electrode plate 31, a negative electrode plate 41, and a separator 20, which are wound together, and a battery case 50.

The battery case 50 includes a case main body 51, a closing lid 52, and a safety valve 57.

The case main body 51 is a container made of metal shaped in a bottom-closed rectangular box-like form having an open upper end. The plate-like closing lid 52 made of metal closes the open end of the main body 51. Thus, the battery case 50 sealingly contains the power generating element 10 set therein and an electrolyte not shown. The lid 52 is provided with the safety valve 57 on the upper side in FIG. 1.

The power generating element 10 includes the strip-shaped positive electrode plate 31 comprising an aluminum foil 32 made of aluminum and positive active material layers 38 supported thereon, the strip-shaped negative electrode plate 41 comprising a copper foil 42 made of copper and negative active material layers 48 supported thereon, and the separator 20. This power generating element 10 is a wound power generating element in which the positive electrode plate 31 and the negative electrode plate 41 are wound into a flat form by interposing therebetween the separator 20 which is of a strip shape similar to but narrower than the electrode plates 31 and 41 (see FIG. 2). The separator 20 includes a resin base layer 21 made of a plurality of synthetic resins and an inorganic oxide layer 27 layered on one side of this resin base layer 21 in its thickness direction DT.

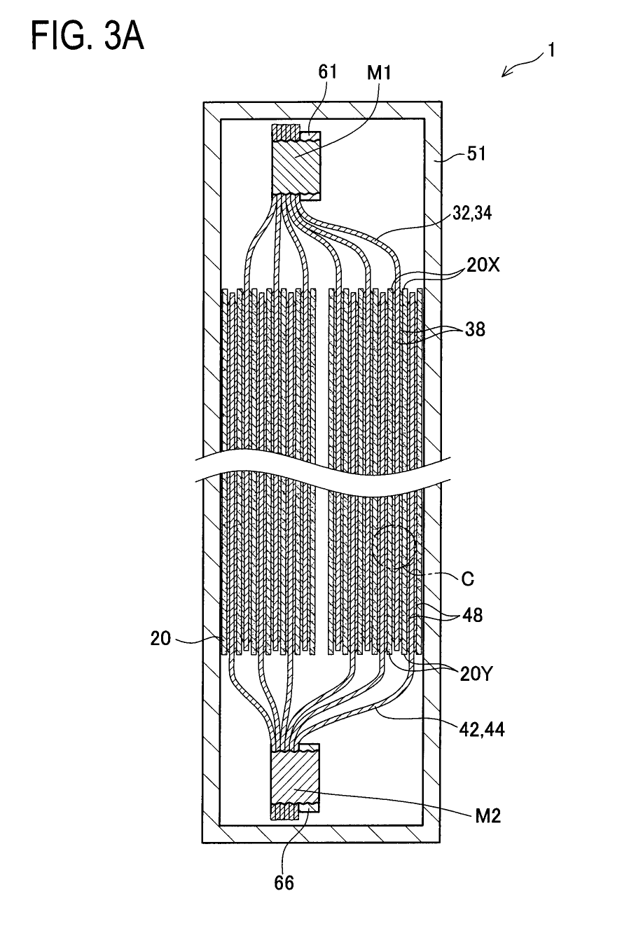

The aluminum foil 32 includes an aluminum supporting portion 33 that supports the positive active material layers 38 on both sides and an aluminum-foil exposed portion 34 in which the aluminum foil 32 itself is exposed to the outside without supporting the positive active material layers 38 (see FIGS. 3A and 3B).

The aluminum-foil exposed portion 34 extends outward (rightward in FIG. 1) from a first long edge 20X of the separator 20 in the power generating element 10 and is exposed toward the outside of the power generating element 10. This aluminum-foil exposed portion 34 is wound so that one portion and another portion are laminated and such a part of the aluminum-foil exposed portion 34 which is closely laminated are connected to a positive current collector 61 made of aluminum (see FIGS. 2 and 3A). This positive current collector 61 has a crank-like bent shape to pass through the lid 52 from the inside of the battery case 50 to protrude upward from the lid 52 in FIG. 1, forming a positive terminal 63.

Each positive active material layer 38 consists of 87 wt % of lithium nickel oxide (LiNiO₂) constituting a positive active material, 10 wt % of acetylene black constituting a conducting agent, 1 wt % of polytetrafluoroethylene (PTFE) constituting a binding agent, and 2 wt % of carboxymethyl cellulose (CMC).

The copper foil 42 includes a copper foil supporting portion 43 that supports the negative active material layers 48 on both sides and a copper-foil exposed portion 44 in which the copper foil 42 itself is exposed to the outside without supporting the negative active material layers 48 (see FIGS. 3A and 3B).

The copper-foil exposed portion 44 extends outward (leftward in FIG. 1) from a second long edge 20Y of the separator 20 and is exposed toward the outside of the power generating element 10. This copper-foil exposed portion 44 is wound so that one portion and another portion are laminated and such a closely laminated part of the copper-foil exposed portions 44 which are closely laminated are connected to a negative current collector 66 made of copper (see FIG. 3A). This negative current collector 66 has a crank-like bent shape to pass through the lid 52 from the inside of the battery case 50 to protrude upward from the lid 52 in FIG. 1, forming a negative terminal 68.

The negative active material layer 48 consists of 98 wt % of graphite constituting a negative active material and 2 wt % of a binding agent.

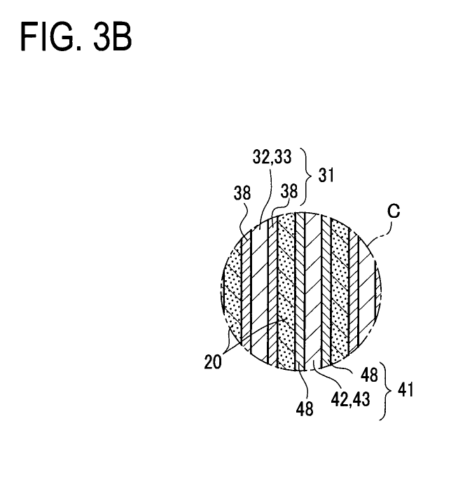

The resin base layer 21 of the separator 20 includes, as shown in FIG. 4, a polyethylene layer 21E made of polyolefin polyethylene and a polypropylene layer 21P made of polyolefin polypropylene.

To be concrete, the resin base layer 21 is made in such a manner that film-like polypropylene layers 21P each having a film thickness of 8.0 μm are laminated on both sides of the film-like polyethylene layer 21E having a film thickness of 4.0 μm in the thickness direction DT of the separator 20. A melting point of the polyethylene forming the polyethylene layer 21E is 130° C. and a melting point of the polypropylene forming the polypropylene layers 21P is 160° C. Both the melting points are lower than the temperature that causes thermal runaway of the battery 1 (e.g., 1000° C. or higher). Accordingly, the resin base layer 21 can provide the aforementioned shutdown function.

On the other hand, the inorganic oxide layer 27 of the separator 20 is layered on the polypropylene layer 21P of the resin base layer 21. This inorganic oxide layer 27 is made of first particles P1 which are independent (separate) single crystal particles made of magnesium oxide (MgO), second particles P2 which are connected particles comprising single crystals made of aluminum oxide (Al₂O₃) and integrally connected to each other in chains, and polyvinylidene fluoride (hereinafter, also referred to as PVDF) constituting a binding agent (not shown) that binds those first particles P1 and second particles P2.

The magnesium oxide used as the first particles P1 and the aluminum oxide used as the second particles P2 are both stable and thus can prevent defects such as dissolution of components.

Furthermore, those magnesium oxide and aluminum oxide are lower in cost than other inorganic oxides and thus can achieve a reduction in cost of the inorganic oxide layer 27 and hence the battery 1.

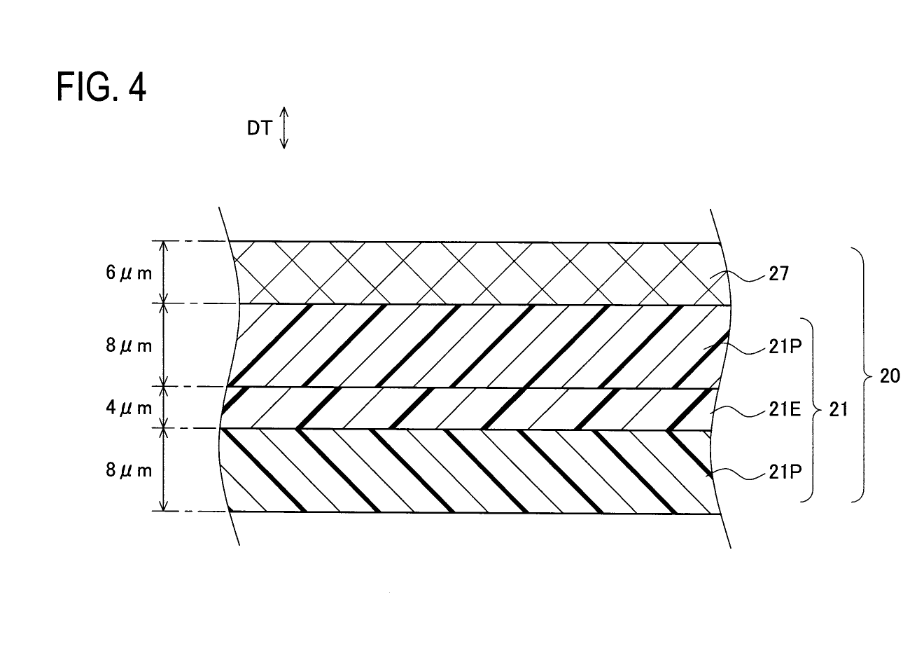

The particle diameter of each of the first particles P1, which are separated from each other, is 0.05 to 0.30 μm and a specific surface area (a surface area per unit mass) according to the BET method is 9.0 to 13.0 m²/g (see FIG. 5).

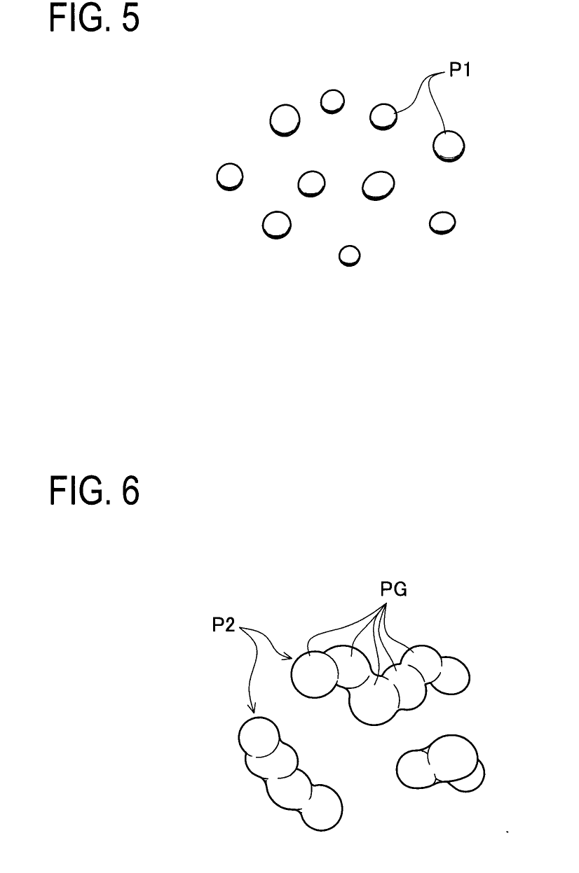

On the other hand, the second particles P2 are the connected particles comprising a plurality of particulate parts PG each made of a single crystal, which are integrally connected to each other in chains, as shown in FIG. 6. The particle diameter of the second particles P2 is 1 to 3 μm and a specific surface area measured by the BET method is 4.0 to 8.0 m²/g.

The present inventors checked out battery performance (battery output) and battery safety on various mass ratios between the first particles P1 and the second particles P2 in the inorganic oxide layer 27.

To be concrete, batteries were produced so that the aforementioned batteries 1 were different in only separator 20.

In the separators 20, the film thickness of the resin base layers 21 were equally 20 μm and the film thickness of the inorganic oxide layers 27 were equally 6 μm. A battery A in Example 1 was produced under the condition that a mass ratio between the first particles P1 and the second particles P2 with respect to a total mass of the first particles P1 and the second particles P2 in the inorganic oxide layer 27 was set to P1:P2=5:95. In a similar manner, a battery B in Example 2 was produced with a relation of P1:P2=10:90, a battery C in Example 3 was produced with a relation of P1:P2=15:85, and a battery D in Example 4 was produced with a relation of P1:P2=20:80, a battery E in Example 5 was produced with a relation of P1:P2=25:75, and a battery F in Example 6 was produced with a relation of P1:P2=30:70, respectively.

On the other hand, as batteries in comparative examples, a battery G (Comparative example 1) was produced by making an inorganic oxide layer of the separator including only the second particles P2 without including the first particles P1 (a mass ratio between the first particles P1 and the second particles P2 is P1:P2=0:100) and a battery H (Comparative example 2) was produced by making the separator including only a resin base layer having a film thickness of 25 μm without including an inorganic oxide layer.

TABLE 1

| | Layer | Layer Film | | | |
|---|---|---|---|---|---|
| | thickness | thickness of | Mass ratio between | | |
| | of | inorganic | 1^{st} and 2^{nd} particles | | |
| | resin base | oxide | 1^{st} | 2^{nd} | |
| | layer | layer | particles | particles | Porosity |
| | (μm) | (μm) | P1 (wt %) | P2 (wt %) | (%) |
| Example 1 | 20 | 6 | 5 | 95 | 47.5 |
| (Battery A) | | | | | |
| Example 2 | 20 | 6 | 10 | 90 | 47.7 |
| (Battery B) | | | | | |
| Example 3 | 20 | 6 | 15 | 85 | 47.9 |
| (Battery C) | | | | | |
| Example 4 | 20 | 6 | 20 | 80 | 50.0 |
| (Battery D) | | | | | |
| Example 5 | 20 | 6 | 25 | 75 | 51.0 |
| (Battery E) | | | | | |
| Example 6 | 20 | 6 | 30 | 70 | 52.0 |
| (Battery F) | | | | | |
| Comparative | 20 | 6 | 0 | 100 | 45.0 |
| Example 1 | | | | | |
| (Battery G) | | | | | |
| Comparative | 25 | 0 | — | — | — |
| Example 2 | | | | | |
| (Battery H) | | | | | |

Of the batteries A to H mentioned above, the porosity of each of the batteries A to G including the inorganic oxide layers 27 is shown in Table 1. This porosity is expressed by the following formula:

Porosity(%)={1−(W/ρ)/(L1×L2×T)}×100

where
W: Weight (g) of the inorganic oxide layer (a difference obtained by subtracting the weight of the resin base layer from the weight of the separator)
ρ: Density (g/cm³) of the inorganic oxide (theoretical density calculated from physical value)
L1: Size (cm) of the inorganic oxide layer in a long-side direction
L2: Size (cm) of the inorganic oxide layer in a short-side direction
T: Length (cm) of the inorganic oxide layer (a difference by subtracting the thickness of the resin base layer from the thickness of the separator).

According to Table 1, of the batteries A to G, the battery G including the first particles P1 with a lowest ratio has a lowest porosity value (45.0%) and, in contrast, the battery F including the first particles P1 with a highest ratio has a highest porosity value (52.0%). As the ratio of the first particles P1 is higher, the porosity of the relevant battery is higher. This reveals that when the ratio of the first particles P1 in the inorganic oxide layer 27 is increased, more pores are formed in the inorganic oxide layer 27.

The present inventors therefore conducted the following test on each battery A to H to search a battery including an inorganic oxide layer having appropriate pores capable of maintaining battery performance.

<Nail Penetration Test>

A nail penetration tests was performed on each of the above batteries A to H. This test is a known test that simulates an internal short circuit in a battery. This test allows evaluation of the safety of each battery.

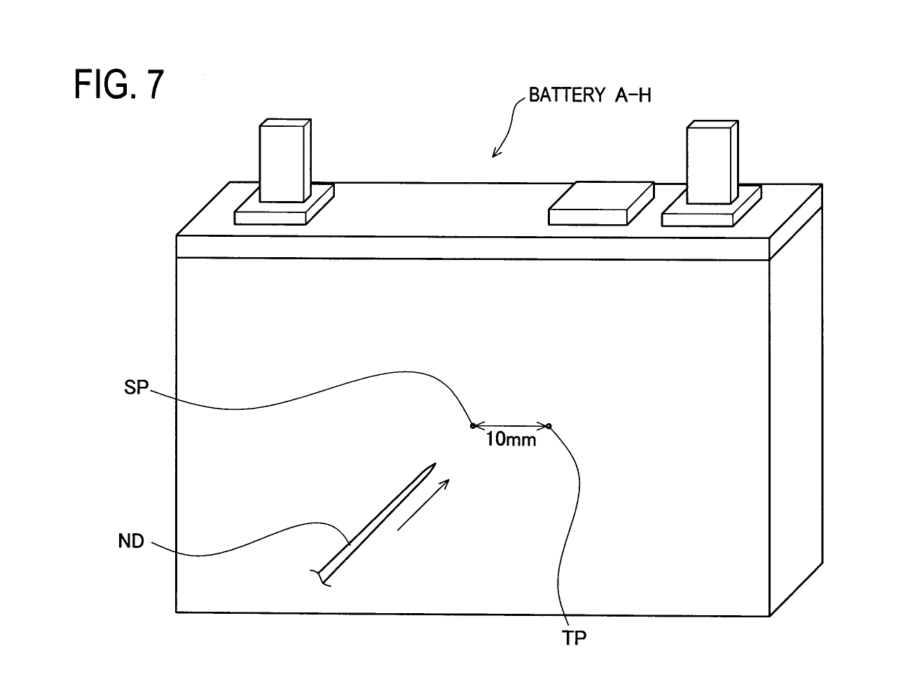

Specifically, as shown in FIG. 7, a needle (a nail) ND made of iron with a diameter of 2.0 mm is moved, perpendicularly, to a side surface having a largest surface area of the battery case of each battery at a moving speed of 5 mm/sec. Voltage in each battery at that time has been adjusted in advance to 4.1V. A tip of the needle ND is then stuck into a center point SP of the side surface of the battery case. At a point TP, 10 mm apart from the center point SP, the temperature of the battery (the surface temperature of the battery case) under the test was measured by a thermocouple.

TABLE 2

| | | | | | Charge-discharge | |
|---|---|---|---|---|---|---|
| | Nail penetration test | | Battery output test | | Cycle test | |
| | (Maximum | | (Battery | | (Output | |
| | temp. | | output value | | retention | |
| | [° C.]) | Evaluation | [W]) | Evaluation | ratio [%]) | Evaluation |
| Example 1 | 77 | ◯ | 575 | ◯ | 99.7 | ◯ |
| (Battery A) | | | | | | |
| Example 2 | 80 | ◯ | 577 | ◯ | 99.0 | ◯ |
| (Battery B) | | | | | | |
| Example 3 | 83 | ◯ | 580 | ◯ | 98.6 | ◯ |
| (Battery C) | | | | | | |
| Example 4 | 82 | ◯ | 582 | ◯ | 98.8 | ◯ |
| (Battery D) | | | | | | |
| Example 5 | 88 | ◯ | 590 | ◯ | 96.8 | Δ |
| (Battery E) | | | | | | |
| Example 6 | 87 | ◯ | 603 | ◯ | 93.0 | Δ |
| (Battery F) | | | | | | |
| Comparative | 75 | ◯ | 550 | X | 99.1 | ◯ |
| Example 1 | | | | | | |
| (Battery G) | | | | | | |
| Comparative | 130 | X | 605 | ◯ | 99.3 | ◯ |
| Example 2 | | | | | | |
| (Battery H) | | | | | | |

Table 2 shows a maximum value of the measured temperatures of each battery. The maximum temperature values were evaluated by a mark “O” representing a temperature less than 100° C. and a mark “X” representing a temperature 100° C. or more.

From the results of the nail penetration test, it is found that the maximum temperature values of the batteries A to F in Examples 1 to 6 and that of the battery G in Comparative example 1, each of which includes the inorganic oxide layer in the separator, are less than 100° C. (O), whereas the battery H in Comparative example 2 including no inorganic oxide layer is 100° C. or higher (X).

This is conceivably because, in the batteries A to G each including the inorganic oxide layer in the separator, even when each resin base layer melts due to heat generated by a local short circuit resulting from the nail penetration, the distance between the positive electrode plate and the negative electrode plate is ensured by at least the thickness of the inorganic oxide layer, and thus the heat generation caused by the short circuit does not continue.

<Battery Output Test>

Separately, a battery output test was performed on the batteries A to H. In this battery output test, the magnitude of battery output (a product of discharge current and voltage) which each battery can maintain for a predetermined time (e.g., 10 seconds) is measured.

To be concrete, battery voltage of each battery was adjusted to 3.74 V (a charge state corresponds to SOC 60%) in a constant-temperature bath with an internal temperature set at 25° C., and then each battery was discharged at a constant electric power (every 100 W in a range of 200 W to 800 W) until this battery voltage came to 3.0 V. Each required time thereof was measured. Based on each result, an approximate expression representing a relationship between electric power and a required time was obtained. Base on this, an electric power (battery output) value of each battery was calculated under the condition that the required time was 10 seconds.

In other words, a battery output value at which the battery voltage of each battery exactly decreased from 3.74 V to 3.0 V for 10 seconds was obtained (see Table 2).

The battery output values were evaluated by a mark “O” representing 560 W or higher and a mark “X” representing less than 560 W. From the results of this battery output test, it is found that the battery output values of the batteries A to F in Examples 1 to 6 are good (O) but the battery G in Comparative example 1 is insufficient.

This is conceivably due to the following factor. In the batteries A to F in Examples 1 to 6, the porosity of each inorganic oxide layer 27 is higher than that of the battery G in Comparative example 1 (see Table 1). Accordingly, the inorganic oxide layers 27 retain more electrolyte and hence lithium ions are easy to disperse.

The above results reveal that the batteries A to F in Examples 1 to 6, that is, the batteries A to F including the first particles P1 and the second particles P2 in respective inorganic oxide layers 27 can ensure safety (the nail penetration test) and further provide sufficient battery output.

<Charge-Discharge Cycle Test>

Separately, the batteries A to H were subjected to a charge-discharge cycle test with a high temperature (60° C.). In this test, it is evaluated the extent to which each battery can retain own battery output under the condition that each battery is repeatedly charged and discharged in a high-temperature environment in which deterioration is apt to relatively advance.

To be specific, battery output is measured at 25° C. in a similar manner to the aforementioned battery output test, and then charge and discharge are repeated 500 cycles in a range of battery voltage of 3.0 V to 4.2 V in a constant-temperature bath set at an internal temperature of 60° C.

For a charge time of the charge and discharge cycles, each battery is subjected to constant current charge with a constant current (charge current: 2 C) until the battery voltage reaches 4.2 V and then subjected to constant voltage charge with a constant voltage (4.2 V) for three hours with a charge current gradually decreasing from 2 C. For a discharge time, on the other hand, each battery is subjected to constant current discharge with a constant current (discharge current: 2 C) until the battery voltage comes to 3.0 V. The charge and discharge under the above conditions were continuously repeated 500 cycles and then the battery output of each battery was measured again.

Table 2 shows a battery output retention ratio of each battery after the charge-discharge cycle test, that is, the battery output after the test in percentage with respect to the battery output of each battery before the test assumed as 100%. Those values are evaluated by a mark “O” representing 98% or more, a mark “Δ” representing 90% or more but less than 98%, and a mark “X” representing less than 90%.

The results of this charge-discharge cycle test reveal that the battery output retention ratios of the batteries A to F in Examples 1 to 6 are all good (0, Δ).

From the above results, it is found that the batteries A to F in Examples 1 to 6, that is, the batteries including the first particles P1 and the second particles P2 in the inorganic oxide layers 27 can retain battery output.

This is conceivably because the second particles P2 are the connected particles comprising a plurality of particulate parts PG connected in chains, so that the porosity of each inorganic oxide layer 27 can be maintained by the existence of the second particles P2 even when the battery expands or contracts due to charge and discharge.

Of the batteries A to F in Examples 1 to 6, it is further found that the batteries A to D in Examples 1 to 4 are preferable because they can retain respective battery outputs higher (O) than the batteries E and F in Examples 5 and 6.

This is conceivably due to the following factor. Of the batteries A to F in Examples 1 to 6, the batteries E and F each including the second particles P2 which are the connected particles at a weight ratio of 75 wt % and 70 wt % respectively are likely to compress and squash the inorganic oxide layers 27 due to expansion and contraction occurring in association with charge and discharge. Thereby, the porosity of each inorganic oxide layer 27 slightly lowers. The batteries E and F therefore cannot retain sufficient battery outputs. In contrast, it is assumed that the batteries A to D in Examples 1 to 4 each including the second particles P2 at a weight ratio of 80 wt % or more can maintain appropriate porosity by such second particles P2.

Consequently, the batteries corresponding to the batteries A to D in Examples 1 to 4, including 80 to 95 wt % of the second particles P2 in the inorganic oxide layers 27 with respect to the total mass of the first particles P1 and the second particles P2, are able to reliably retain battery output. Such batteries are therefore more preferable.

A method of producing the battery 1 in the first embodiment will be explained below.

Firstly, the resin base layer 21 of the separator 20 is made by laminating film-strip-shaped polypropylene layers 21P each having a film thickness of 8.0 μm on both sides of a film-strip-shaped polyethylene layer 21E having a film thickness of 4.0 μm

On the other hand, magnesium oxide powder corresponding to the first particles P1, aluminum oxide powder corresponding to is the second particles P2, PVDF constituting the binding agent, an appropriate amount of solvent (N-methyl-2-pyrrolidone (NMP) in the first embodiment) are mixed to produce a paste (not shown). The weight ratio between the first particles P1 and the second particles P2 is selected according to Examples 1 to 6 shown in Table 1. 5 wt % of PVDF with respect to the above weights is added to prepare six kinds of pastes to be used in Examples 1 to 6 respectively.

The above pastes are individually applied on one side of each resin base layer 21 in the thickness direction DT by use of gravure printing to provide a film thickness of 6 μm after drying, and then sufficiently dried. The separators 20 including the resin base layers 21 and the inorganic oxide layers 27 are thus completed.

Thereafter, the above separators 20 are interposed one each between the positive electrode plates 31 and the negative electrode plates 41 which are separately prepared and they are wound to produce wound power generating elements 10. Furthermore, the positive current collectors 61 and the negative current collectors 66 are welded to the power generating elements 10 respectively. Each assembly is inserted in each case body 51. An electrolyte (not shown) is poured in each case body 51, and then the closing lids 52 are welded to the case bodies 51 to close the openings thereof. Thus, the batteries 1 are completed (see FIG. 1).

### Second Embodiment

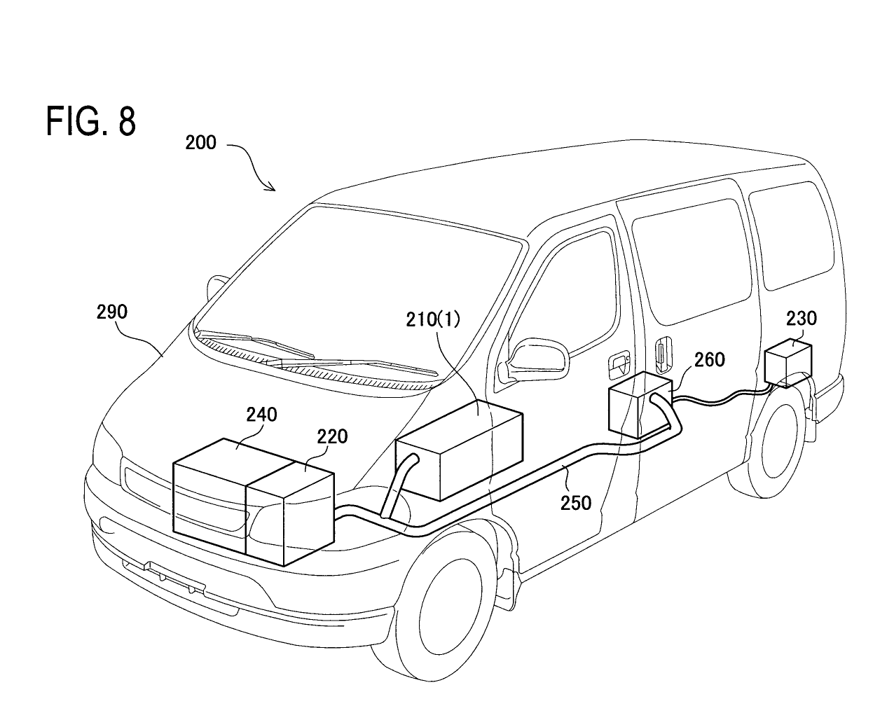

A vehicle 200 in a second embodiment mounts a plurality of the batteries 1 mentioned above. To be concrete, as shown in FIG. 8, the vehicle 200 is a hybrid electric vehicle to be driven by a combination of an engine 240, a front electric motor 220, and a rear electric motor 230. This vehicle 200 includes a vehicle body 290, the engine 240, the front electric motor 220 attached thereto, the rear electric motor 230, a cable 250, an inverter 260, and a battery assembly 210 including the batteries 1 therein.

The vehicle 200 in the second embodiment, which mounts the aforementioned batteries 1, can be provided as a vehicle 200 using the safer batteries 1 and being able to retain battery output, thereby maintaining vehicle performance.

### Third Embodiment

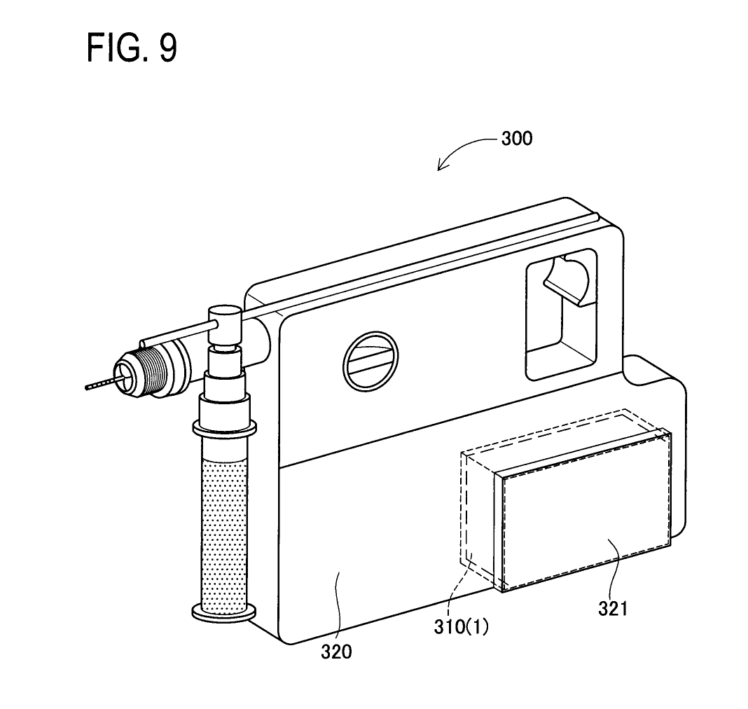

A hammer drill 300 in a third embodiment mounts a battery pack 310 including the aforementioned battery 1 and, as shown in FIG. 9, a battery-mounting equipment including the battery pack 310 and a main body 320. The battery pack 310 is removably placed in a bottom section 321 of the main body 320 of the hammer drill 300.

The hammer drill 300 in the third embodiment, which mounts the aforementioned battery 1, can be provided as a battery-mounting equipment using the safer battery 1 and being able to retain battery output, thereby maintaining own function.

The present invention is explained in the above first, second, and third embodiments but is not limited thereto. The present invention may be embodied in other specific forms without departing from the essential characteristics thereof.

For instance, the first embodiment exemplifies the battery using the wound power generating element. As an alternative, the present invention may be applied to a battery using a laminated power generating element in which a plurality of positive electrode plates and a plurality of negative electrode plates are alternately laminated by interposing separators therebetween. Although the separator mentioned above includes the inorganic oxide layer laminated on one side of the resin base layer, it may include inorganic oxide layers on both sides of the resin base layer.

The above resin base layer is made of one polyethylene layer and two polypropylene layers in combination. As an alternative, for example, the resin base layer may be made of only one polyethylene layer, only one polypropylene layer, or a combination of one polyethylene layer and one polypropylene layer. The above embodiments use magnesium oxide as the first inorganic oxide and aluminum oxide as the second inorganic oxide. An alternative is to use ferric oxide (FeO, Fe₂O₃), silicon dioxide (SiO₂), titanium oxide (TiO₃), barium titanate (BaTiO₃), and others. As another alternative, the first inorganic oxide and the second inorganic oxide may be composed of the same compositions.

1. A battery comprising a positive electrode plate, a negative electrode plate, and a separator interposed between the positive electrode plate and the negative electrode plate, wherein
the separator includes:
a porous resin layer made of polyolefin synthetic resin; and
an inorganic oxide layer laminated on at least one side of the resin layer in a thickness direction,
the inorganic oxide layer includes:
first particles made of first inorganic oxide in the form of separate single crystal particles; and
second particles made of second inorganic oxide in the form of connected particles comprising a plurality of particulate parts integrally connected to each other in chains, each particulate part being made of a single crystal,
the first inorganic oxide is magnesium oxide,
the second inorganic oxide is aluminum oxide, and
the inorganic oxide layer includes 80 to 95 wt % of the second particles with respect to a total weight of the first particles and the second particles.

2. (canceled)

3. A vehicle that mounts the battery set forth in claim 1.

4. A battery-mounting equipment that mounts the battery set forth in claim 1.
